(19) United States
(12) Patent Application Publication
(10) Pub. No.: US 2026/0159000 A1
(43) Pub. Date: Jun. 11, 2026

(54) VEHICLE STORAGE COMPARTMENT HAVING RF BLOCKER

(71) Applicant: Ford Global Technologies, LLC, Dearborn, MI (US)

(72) Inventors: Laura Joselyn Varela Huerta, Mexico City (MX); David Alejandro Vazquez, Nezahualcoyotl (MX); Carlos Eduardo Bernal, Ciudad López Mateos (MX); Esmeralda Arenas Lopez, Atitalaquia (MX)

(73) Assignee: Ford Global Technologies, LLC, Dearborn, MI (US)

(21) Appl. No.: 18/976,465

(22) Filed: Dec. 11, 2024

(51) Int. Cl. B60R 5/02

(52) U.S. Cl. CPC B60R 5/02

(57) ABSTRACT

A vehicle storage compartment having a housing with an upper storage compartment and a hidden lower storage compartment. An upper panel defines a bottom floor of the upper storage compartment. A lower floor is located below the upper panel, and a hidden lower storage compartment extends between the upper panel and the lower floor. A radio frequency blocker is provided in at least the upper panel to block transmission of radio frequency signals through the upper panel.

### FIELD OF THE DISCLOSURE

The present disclosure generally relates to motor vehicle storage compartments, and more particularly relates to a storage compartment assembly that may be utilized in a vehicle compartment such as a front trunk.

### BACKGROUND OF THE DISCLOSURE

Motor vehicles are commonly equipped with storage compartments. For example, some motor vehicles such as sedans may include a rear trunk. In addition, electric vehicles typically include a front trunk storage area commonly referred to as a frunk that offers a rear storage compartment. It may be desirable to provide for a storage compartment that provides for enhanced organization and efficient use of a vehicle compartment and blocks radio frequency (RF) signal transmissions.

### SUMMARY OF THE DISCLOSURE

According to a first aspect of the present disclosure, a vehicle storage compartment having a housing with an upper storage compartment and a hidden lower storage compartment. An upper panel defines a bottom floor of the upper storage compartment. A lower floor is located below the upper panel, and a hidden lower storage compartment extends between the upper panel and the lower floor. A radio frequency blocker is provided in at least the upper panel to block transmission of radio frequency signals through the upper panel.

Embodiments of the first aspect of the present disclosure can include any one or a combination of the following features:
the housing defines a frunk of the vehicle;
the frunk has a hood panel;
the radio frequency blocker is further provided in sidewalls of the hidden compartment;
the radio frequency blocker is further provided in the lower floor;
the radio frequency blocker comprises a conductive material;
the conductive material comprises a Faraday fabric;
the lower floor comprises a polymeric layer, an interior lining and the Faraday fabric;
the Faraday fabric is disposed between the polymeric layer and the interior lining;
a lock is provided on the upper panel; and
the lock may be actuated remotely by an electronic device.

According to a second aspect of the present disclosure, a motor vehicle having a frunk located generally proximate a front end of the motor vehicle and a vehicle storage compartment. The vehicle storage compartment includes a housing with an upper storage compartment and a hidden lower storage compartment. An upper panel defines a bottom floor of the upper storage compartment. A lower floor is located below the upper panel, and a hidden lower storage compartment extends between the upper panel and the lower floor. A radio frequency blocker is provided in at least the upper panel to block transmission of radio frequency signals through the upper panel.

Embodiments of the second aspect of the present disclosure can include any one or a combination of the following features:
the frunk has a hood panel;
the radio frequency blocker is further provided in sidewalls of the hidden compartment;
the radio frequency blocker is further provided in the lower floor;
the conductive shield comprises a Faraday fabric;
the lower floor comprises a polymeric layer, an interior lining and the Faraday fabric;
the Faraday fabric is disposed between the polymeric layer and the interior lining;
a lock provided on the upper panel; and
the lock may be actuated remotely with an electronic device.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front upper perspective view of a motor vehicle having a frunk providing a front storage compartment, according to one embodiment;

FIG. 2 is an enlarged upper perspective view of the frunk with the storage compartment having an upper compartment and a hidden lower compartment;

FIG. 3 is an upper perspective view of the storage compartment with the lower compartment lid in the closed position;

FIG. 3A is an enlarged perspective view of section III taken from FIG. 3;

FIG. 4 is an upper perspective view of the storage compartment with the lower compartment lid in the open position;

FIG. 5 is an exploded view of the storage compartment exploded from the frunk;

FIG. 6 is a cross-sectional view taken through line VI-VI of FIG. 5 illustrating the material make up of the lower compartment lid; and

FIG. 7 is a block diagram illustrating controls for controlling the lock mechanism according to one example.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure,

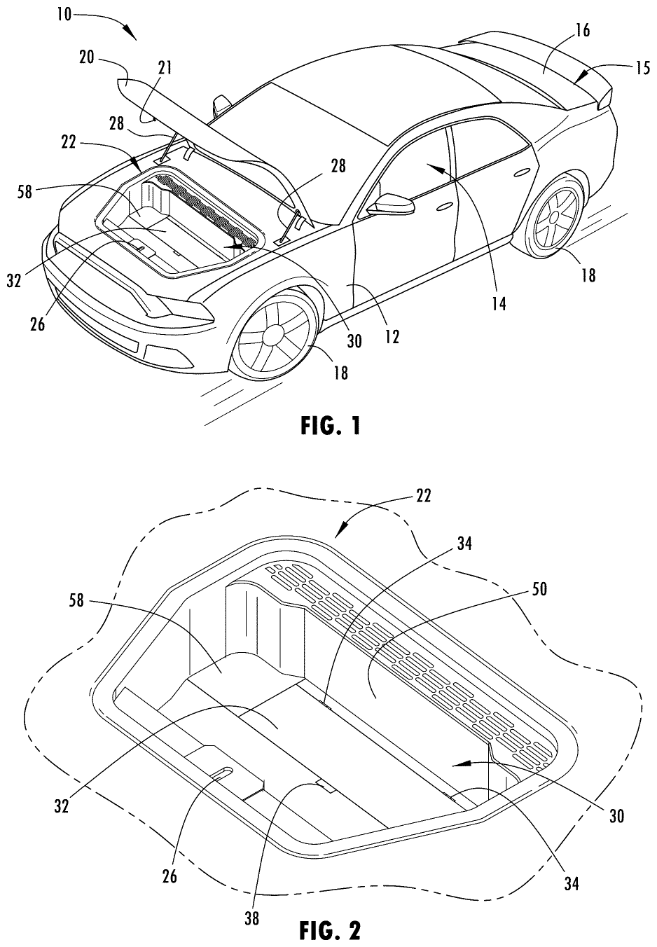

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle storage compartment. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination,

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise,

Referring to FIG. 1, an automotive or motor vehicle 10 is generally illustrated having a storage compartment 30 installed in a front trunk, also referred to herein as a frunk 22, accessible at the front end of the motor vehicle 10. The motor vehicle 10 generally includes a vehicle body 12 which may include body panels, doors, a roof, a floor and windows, generally defining a cabin interior 14, also referred to as a passenger compartment. The cabin interior 14 generally includes seating assemblies for seating one or more passengers and a driver of the motor vehicle 10. The motor vehicle 10 shown and described herein is a wheeled motor vehicle having a plurality of tire and wheel assemblies 18. In one example, the motor vehicle 10 shown and described herein is a sedan style vehicle, however, it should be appreciated that the motor vehicle 10 may be a truck, a sport utility vehicle (SUV), a van, a bus or other motor vehicle configured with an accessible space configurable to serve as the storage compartment 30 capable of storing cargo items.

The motor vehicle 10 further includes a rear trunk 15, generally rearward of the passenger compartment, accessible at the rear end of the motor vehicle 10 which typically includes a trunk lid 16 that covers a storage compartment of the rear trunk 15 which is available for storing cargo items. In addition, the motor vehicle 10 has the front trunk or frunk 22 generally at the front end of the motor vehicle 10, generally forward of the passenger compartment. The frunk 22 defines a storage compartment 30 and includes a hood panel 20 on top which may rotate about hinges between a closed position concealing the storage compartment of the frunk 22 and an open position supported open by support arms 28 that exposes the frunk 22 and allows access to the storage compartment 30 in the frunk 22 and cargo items contained therein. In the closed position, the frunk hood panel 20 has a striker 21 that is latched onto a releasable hood latch 26 to latch the hood panel 20 fixed in place. The hood latch 20 thereby covers the storage compartment 30 and conceals cargo items that are stored in the frunk 22. In the open position, a user may place and access cargo items stored in the storage compartment 30 within the frunk 22.

The motor vehicle 10 may be a battery electric vehicle (BEV) in one example that employs battery packs supplying electrical energy for powering one or more electric motors to power and drive the motor vehicle 10. In a battery electric vehicle, the frunk 22 generally has additional space generally available due to the lack of an internal combustion engine, for example. The frunk 22 thereby has an expanded available cargo storage space which includes sidewalls 50 generally defining the upstanding portions of the frunk 22 and a bottom floor 58 as shown in FIG. 2. It should be appreciated that the motor vehicle 10 may otherwise be configured with an internal combustion engine or as a hybrid vehicle having both one or more electric motors and an internal combustion engine, with the motor vehicle 10 configured having one or more storage compartments.

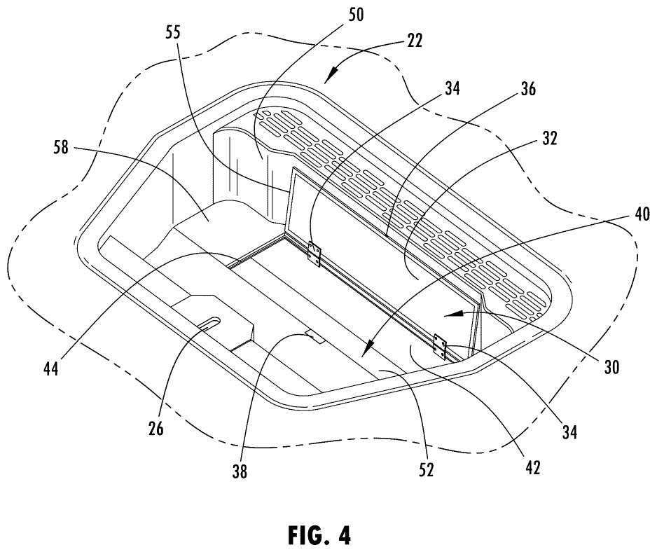

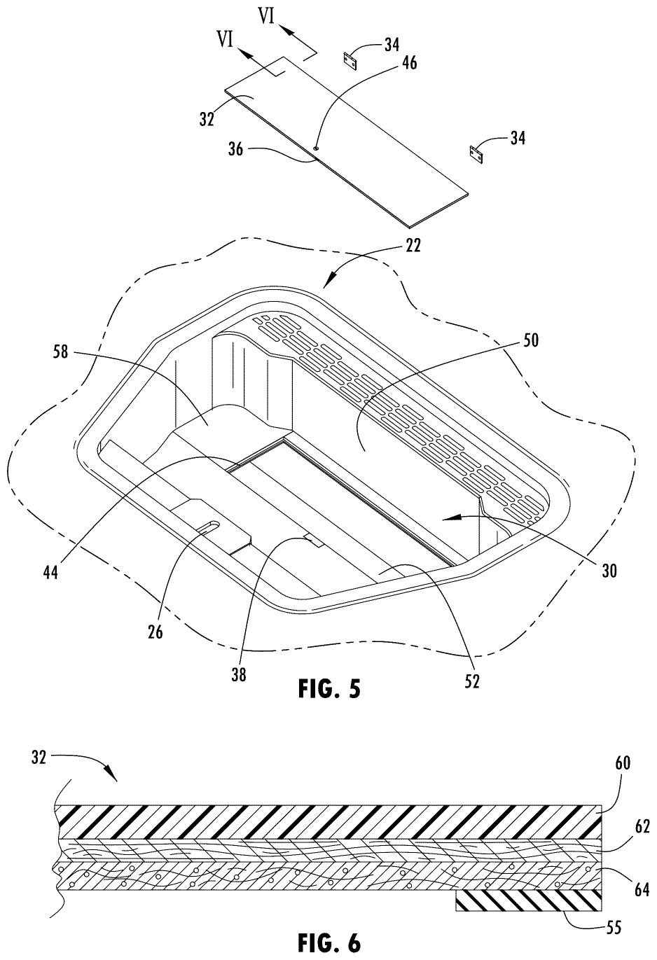

Accordingly, the storage compartment 30 is provided on a motor vehicle 10, particularly in the frunk 22 of the motor vehicle 10, according to one embodiment, to provide efficient and enhanced storage of cargo items in an efficient and organized manner. The vehicle storage compartment 30 includes upstanding sidewalls 50 and the bottom floor 58 which generally serve as a housing to define an upper storage compartment. The vehicle storage compartment 30 also includes a lower storage compartment 40 as seen in FIG. 4 which is located below the floor 58. The vehicle storage compartment 30 has an upper panel 32 that defines a portion of the bottom floor 58 of the upper storage compartment and serves as a hidden cover for the lower storage compartment 40. The lower storage compartment 40 further includes a plurality of sidewalls 42 and a bottom floor 52.

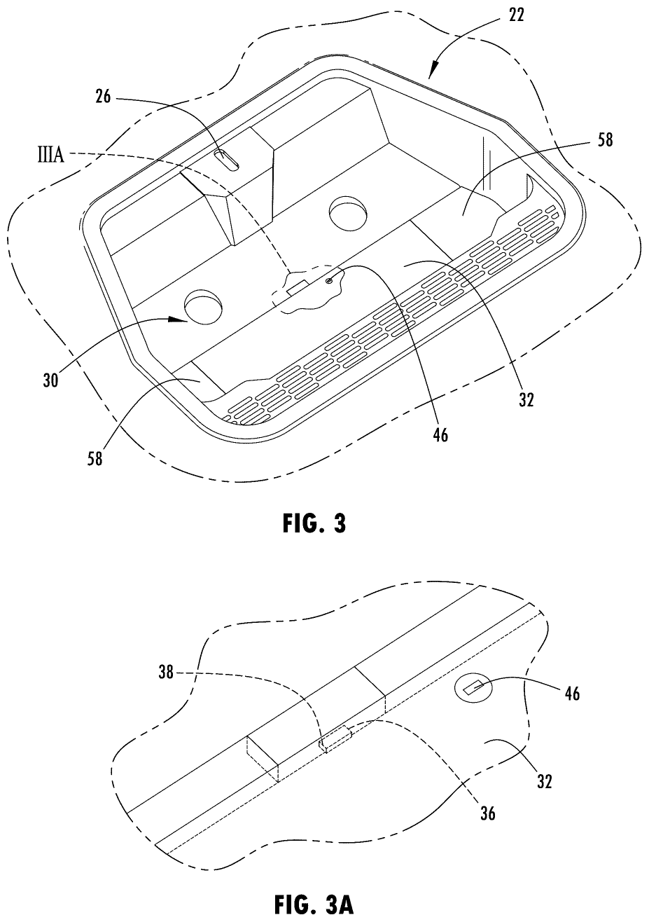

The upper panel 32 is hingedly connected to an upper edge of the rear upstanding wall 42 via a pair of spaced hinges 34. As such, the upper panel 32 is configured to rotate between the horizontal closed position as shown in FIGS. 2 and 3 and the upstanding open position shown in FIG. 4. In the closed position, the upper panel 32 rests on a weatherproof seal strip 44 on a lip extending the periphery of the lower opening and closes off or covers the lower storage compartment 40 such that the lower storage compartment 40 and cargo items stored therein are hidden from view. In addition, the lower storage compartment 40 may include an electronic controlled locking mechanism 38, such as an electric solenoid that may be remotely controlled by a remote electronic device. The locking mechanism 38 may include an electric actuated lock bolt that extends outward and engages a slot 36 in the edge of the upper panel 32 opposite the edge having the pair of hinges 34. As such, the locking mechanism 38 advantageously enables a user to lock the upper panel 32 in the closed position to prevent opening of the upper panel 32 and access to the lower storage compartment 40.

The vehicle storage compartment 30 is configured having the hidden lower storage compartment 40 equipped with an RF signal blocker to block RF signals from being transmitted into or out of the hidden lower storage compartment 40 such that RF signal transmissions to or from an electronic device with signal communication circuitry such as a cell phone, a computer or a tablet, for example, which transmits electromagnetic energy in the form of radio frequency signals. The radio frequency blocker may be configured as an electrically conductive material in the form of a Faraday fabric that forms an electrically conductive shield. The electrically conductive shield may be provided in the upper panel 32 as well as in the sidewalls 42 and the bottom floor 52 to provide a Faraday cage so as to prevent radio frequency signals from being transmitted through the top, sidewalls and bottom of the lower storage compartment 40.

The electrically conductive shield may be configured as an electrically conductive fabric layer 62 as shown in FIG. 6 integrated into the upper panel 32, according to one example. In this example, the upper panel 32 has a polymeric layer 60 such as plastic on one side shown as the top side, a soft interior lining layer 64 on the inside and the electrically conductive Faraday fabric layer 62 disposed between layers 60 and 64. The electrically conductive fabric 62 may include a Faraday fabric that provides the electrically conductive shield. This may include an electric conductive material formed in a mesh, for example,

The electrically conductive shield may include an aluminum fabric or mesh, according to one example. According to another example, the electrically conductive shield may include aluminum, such as a film of aluminum foil, that may be lined on or within at least portions of the structure forming the hidden lower storage compartment 40. For example, the electrically conductive shield may include a layer of aluminum foil disposed between layers 60 and 64 or otherwise on or within the polymeric layer 60 or between lining layer 64 of the upper hidden panel 32,

The lower sidewalls 42 of the hidden lower storage compartment 40 may also include an electrically conductive shield which may be similarly configured as an electrically conductive fabric layer 62 disposed between a polymeric layer 60 and a soft interior lining layer 64 as shown for the upper panel 32 in FIG. 6. As such, the electrically conductive shield advantageously shields and prevents electromagnetic energy in the form of RF signals from being transmitted into and out of the hidden lower storage compartment 40. It should be appreciated that the bottom floor 52 of the hidden lower storage compartment 40 may likewise include an electrically conductive material such as electrically conductive fabric layer 62 disposed between a polymeric layer 60 and a soft interior lining layer 64 as shown for the upper panel 32 in FIG. 6 to shield the bottom portions of the hidden lower storage compartment 40 to block RF signals from being transmitted therethrough.

While the RF signal blocker embodied as an electrically conductive fabric layer 62 forming an electrically conductive shield has been shown and described herein as a fabric layer, according to one example, it should be appreciated that the electrically conductive shield may be configured with other electrically conductive materials such as, for example, a metal foil, a conductive plastic, a conductive mesh and other electrically conductive materials that would shield and prevent the transmission of electromagnetic energy such as RF signals from being transmitted through the structure and to or from one or more electronic devices stored in the hidden lower storage compartment 40.

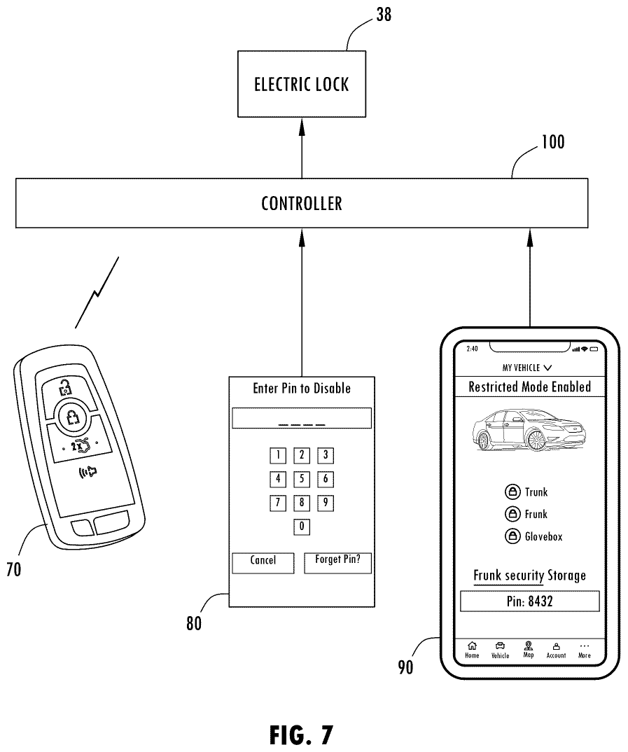

Referring to FIG. 7, a controller 100 is shown for controlling the electric actuable lock mechanism 38. The electric actuable lock mechanism 38 may be controlled by the controller 100 having a microprocessor and memory, for example. It should be appreciated the controller 100 may include dedicated or shared control circuitry and may include other analog and/or digital circuitry. The controller 100 is shown communicating with a plurality of remote devices that enable a user to actuate the electric actuable lock mechanism 38 via communication with the controller 100. The remote control device may include a key fob 70 which may include user inputs to lock and unlock vehicle devices including the electric actuable lock mechanism 38. In addition, the key fob 70 may include a mechanical key that may be utilized to engage a mechanical key lock 46 as a backup to access the hidden lower storage compartment 40. Additionally, the motor vehicle 10 is equipped with a touch screen display 80 which may include user inputs to lock and unlock the electric actuable lock mechanism 38. The user input is shown requiring a security pin input by the user, according to one example. Further, it should be appreciated that the electric actuable lock mechanism 38 may be controlled via a remote communication device 90 such as a mobile phone or a tablet which may communicate via a software application to lock and unlock the electric actuable lock mechanism 38. The remote communication device 90 may likewise include a user security pin input to control the electric actuable lock mechanism 38.

The vehicle storage compartment 30 advantageously provides for a hidden lower storage compartment 40 in a frunk 22 of a motor vehicle 10 that enables items such as electronic devices and other cargo possessions to be hidden from view. The storage compartment 30 further advantageously prevents the transmission of RF signals to or from electronic devices with communication circuitry that may be stored within the hidden lower storage compartment 40. This may be particularly advantageous in preventing the detection of the existence of electronic devices stored in the hidden lower storage compartment 40 with the external electronic detection devices to prevent unwanted detection of the cargo.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle storage compartment comprising:
a housing having an upper storage compartment and a hidden lower storage compartment;
an upper panel defining a bottom floor of the upper storage compartment;
a lower floor located below the upper panel, wherein the hidden lower storage compartment extends between the upper panel and the lower floor; and
a radio frequency blocker provided in at least the upper panel to block transmission of radio frequency signals through the upper panel.

2. The vehicle storage compartment of claim 1, wherein the housing defines a frunk of the vehicle.

3. The vehicle storage compartment of claim 2, wherein the frunk has a hood panel.

4. The vehicle storage compartment of claim 1, wherein the radio frequency blocker is further provided in sidewalls of the hidden compartment.

5. The vehicle storage compartment of claim 4, wherein the radio frequency blocker is further provided in the lower floor.

6. The vehicle storage compartment of claim 1, wherein the radio frequency blocker comprises a conductive material.

7. The vehicle storage compartment of claim 6, wherein the conductive material comprises a Faraday fabric.

8. The vehicle storage compartment of claim 7, wherein the lower floor comprises a polymeric layer, an interior lining and the Faraday fabric.

9. The vehicle storage compartment of claim 8, wherein the Faraday fabric is disposed between the polymeric layer and the interior lining.

10. The vehicle storage compartment of claim 1, further comprising a lock provided on the upper panel.

11. The vehicle storage compartment of claim 10, wherein the lock may be actuated remotely by an electronic device.

12. A motor vehicle comprising:
a frunk located generally proximate a front end of the motor vehicle; and
a vehicle storage compartment, the vehicle storage compartment comprising:
a housing having an upper storage compartment and a hidden lower storage compartment;
an upper panel defining a bottom floor of the upper storage compartment;
a lower floor located below the upper panel, wherein the hidden lower storage compartment extends between the upper panel and the lower floor; and
a radio frequency blocker comprising a conductive shield provided in at least the upper panel to block transmission of radio frequency signals through the upper panel.

13. The motor vehicle of claim 12, wherein the frunk has a hood panel.

14. The motor vehicle of claim 12, wherein the radio frequency blocker is further provided in sidewalls of the hidden compartment.

15. The motor vehicle of claim 14, wherein the radio frequency blocker is further provided in the lower floor.

16. The motor vehicle of claim 15, wherein the conductive shield comprises a Faraday fabric.

17. The motor vehicle of claim 16, wherein the lower floor comprises a polymeric layer, an interior lining and the Faraday fabric.

18. The motor vehicle of claim 17, wherein the Faraday fabric is disposed between the polymeric layer and the interior lining.

19. The motor vehicle of claim 12, further comprising a lock provided on the upper panel.

20. The motor vehicle of claim 19, wherein the lock may be actuated remotely with an electronic device.
